(19) United States
(12) Patent Application Publication
(10) Pub. No.: US 2001/0041196 A1
(43) Pub. Date: Nov. 15, 2001

(54) Clay molding device and mold

(76) Inventor: Yuji Yamane, Tokyo (JP)

Correspondence Address: STAAS & HALSEY LLP, 700 11TH STREET, NW, SUITE 500, WASHINGTON, DC, 20001, US

(21) Appl. No.: 09/845,289

(22) Filed: May 1, 2001

(30) Foreign Application Priority Data
May 15, 2000 (JP) 2000-142097

(51) Int. Cl. B29C 45/02; B29C 45/16; B29C 45/26

(52) U.S. Cl. 425/116; 425/129.1; 425/190; 425/567; 425/318

(57) ABSTRACT

A clay molding device comprises a clay pressing-out tool, which presses filled-up clay out through an opening, and a mold installed as covering the opening of the clay molding device to be attached and detached freely, in which clay is pressed through the opening of the clay pressing-out tool. A hole and/or a notch is formed in the mold, and a portion of the pressed-in clay can be protruded and shaped by the hole and/or the notch. The mold is united with the clay pressed in the inside and the clay protruded and shaped by the hole and/or the notch, and is able to form a portion of the appearance of a clay molded figure.

### BACKGROUND OF THE INVENTION

1. Field of the Invention

The present invention relates to a clay molding device and a mold.

2. Description of Related Art

As a clay molding device, for example, there is the one disclosed in the Japanese Utility Model No. 3059589. In this clay molding device, a mold is installed in an opening of a clay pressing-out tool (a clay filling-up tool), and a desired clay molded figure is formed by pressing the clay, which is pressed out from the pressing-out tool, in the mold.

However, in an earlier clay molding device, the appearance form of a clay molded figure was only transcription of the inner surface form of a mold, so that forms which are put on a clay molded figure were limited.

Further, as an earlier mold of a clay molding device, there is also the one in which a divided mold is used, in order to put comparatively complex appearance form on a clay molded figure. However, it was also only transcription of the inner surface form. Therefore, a clay molded figure having an extravagant form could not be obtained.

### SUMMARY OF THE INVENTION

The present invention was made in view of the above problem. An object of the present invention is to provide a clay molding device and a mold for obtaining a novel, extravagant, and good-appearance clay molded figure.

According to a first aspect of the present invention, the clay molding device comprises a clay pressing-out tool, which presses filled-up clay out through an opening, and a mold installed as covering the opening of the clay molding device to be attached and detached freely, in which clay is pressed through the opening of the clay pressing-out tool. A hole and/or a notch is formed in the mold, and a portion of the pressed-in clay can be protruded and shaped by the hole and/or the notch. The mold may be united with the clay pressed in an inside of the mold and the clay protruded and shaped by the hole and/or the notch, and can form a portion of the appearance of a clay molded figure. The “mold” in the case may be constituted as a divided mold. If it is a divided mold, it becomes easy to clean the clay inside of the mold, when the clay molded figure once molded is broken.

According to the clay molding device, the clay pressed out through the clay pressing-out tool is shaped by pressing it in the mold through the opening, and protruding a portion of the clay through the hole and/or the notch of the mold. Then, a clay molded figure, with which the mold, the clay pressed in the mold, and the clay protruded and shaped by the hole and/or the notch are united, may be obtained.

In the clay molding device of the present invention, also the mold can be divided, and after clay is molded, the mold can be separated from the clay molded figure. Therefore, a clay molded figure with which the clay pressed in the inside of the mold and the clay protruded and shaped by the hole and/or the notch are united, can be obtained.

According to the clay molding device, after the clay is molded, the mold may be separated from the clay molded figure. Then, a clay molded figure, with which the clay pressed in the mold and the clay protruded and shaped by the hole and/or the notch are united, may be obtained.

Further, in the clay molding device of the present invention, the clay molding device may also comprise an extra shaping support tool, with which form is added to the clay protruded and shaped by the hole and/or the notch. The “addition of form” in the case may be either before or after protruding and shaping of clay by the hole and/or the notch.

According to the clay molding device, form can be added to the clay protruded by the hole and/or the notch, as a seasoning.

Moreover, in the clay molding device of the present invention, the main portion of the shaping support tool can be inserted in and pulled out through the hole and/or the notch. The “main portion” in the case means the portion having a function for adding form.

According to the clay molding device, when form is added to clay through the hole and/or the notch before protruding and shaping, in a molding process, an additional form portion may be protruded through the hole and/or the notch.

Furthermore, in the clay molding device of the present invention, the shaping support tool may be constituted as a sub-mold. The sub-mold is installed attachably and detachably on the outside of the mold. Form is added to the clay protruded and shaped by the hole and/or the notch. After the clay is molded, the sub-mold can be taken out. The “sub-mold” in the case may be the one that can be taken out after clay is molded. Further, it may be a divided mold, if needed. Preferably, the “sub-mold” may be transparent, since behavior that the inside is being filled up with clay, can be observed during molding. Moreover, when a “sub-mold” is arranged, the “sub-mold” may be pressed on the (main) mold by human, or the “sub-mold” may be mounted on the mold or clay molding tool by a claw.

According to the clay molding device, complex form can be given on the protruding and shaping portion by the sub-mold.

According to a second aspect of the present invention, the mold comprises a body having a hole and/or a notch. An inside of the mold can be filled up with clay, and clay can be protruded and shaped by using the hole and/or the notch. The mold is united with the clay pressed in the inside and the clay protruded and shaped by the hole and/or the notch, and is able to form a portion of the appearance of a clay molded figure. “Can be protruded and shaped” in the case includes the case that clay is first filled up with handwork in the mold, and a protruding portion is attached to the clay from the outside by using the hole and/or the notch afterwards.

According to the mold, the inside thereof is filled up with clay, and the clay is protruded and shaped by using a hole and/or a notch, so that a clay molded figure having a protruding and shaping portion and making the mold a portion of the appearance, is formed.

According to a third aspect in the present invention, the mold comprises a body having a hole and/or a notch. An inside of the mold can be filled up with clay, and clay can be protruded and shaped by using the hole and/or the notch. The mold can be divided, and after clay is molded, the mold can be separated from the clay molded figure.

According to the mold, the inside thereof is filled up with clay, and after the clay is protruded and shaped by using a hole and/or a notch, the mold is separated, so that a clay molded figure having a protruding and shaping portion, is formed.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a perspective view showing the whole clay molding device according to an embodiment the present invention;

FIG. 2 is a sectional view showing a state that a mold is attached to the clay molding tool of the clay molding device according to the present invention;

FIG. 3 is a perspective view showing a clay shaping process by the clay molding device according to the present invention;

FIG. 4 is a perspective view showing a modified example of the mold and shaping support tool with the clay molding device according to the present invention;

FIG. 5 is a perspective view further showing another modification example of the mold in the clay molding device according to the present invention; and

FIG. 6 is a perspective view furthermore showing another modification example of the mold in the clay molding device according to the present invention.

### PREFERRED EMBODIMENT OF THE INVENTION

The embodiment of the clay molding device according to the present invention will be explained as following, referring to the appended drawings.

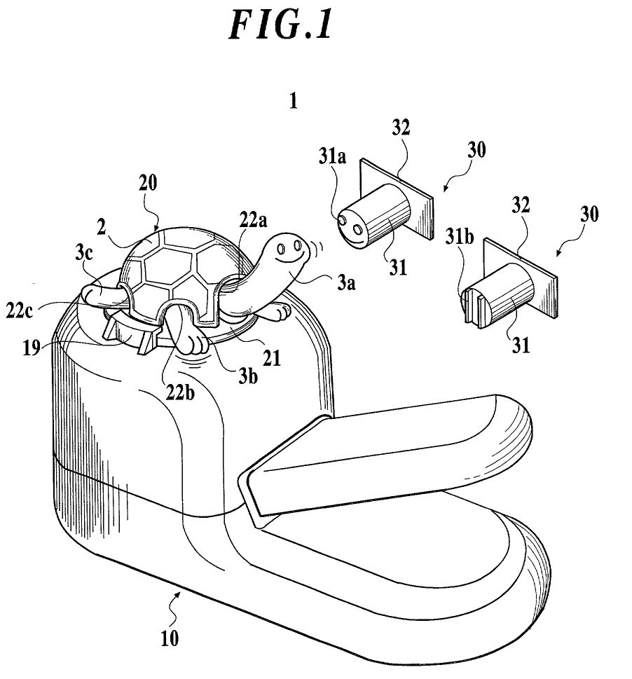

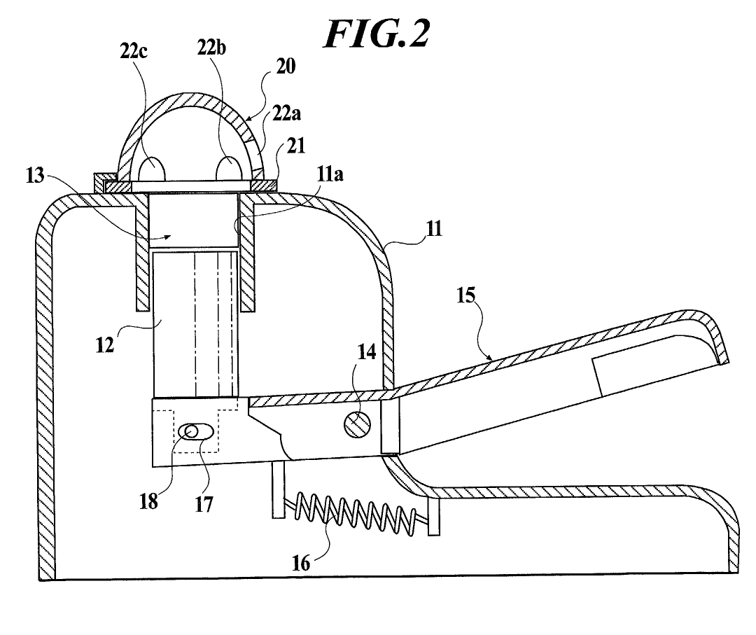

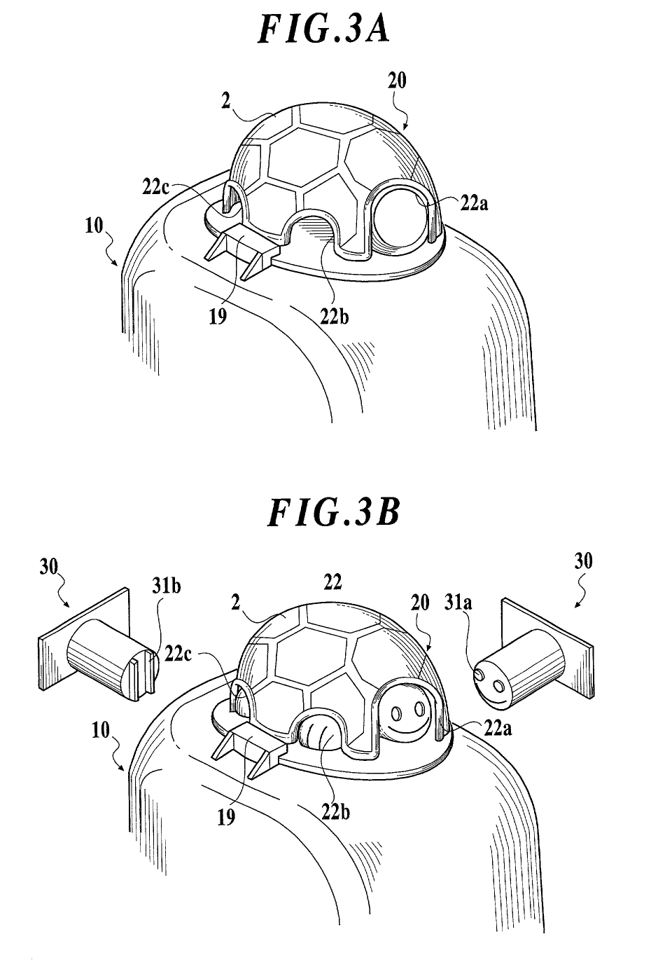

FIGS. 1 to 3 show an embodiment of the clay molding device according to the present invention. FIG. 1 is a perspective view showing the whole device. FIG. 2 is a sectional view showing a state that a mold is attached to the clay pressing-out tool of the device. FIG. 3 is a perspective view showing a clay shaping process by the device.

The clay molding device comprises a clay pressing-out tool 10, which presses clay out, a mold 20, in which the clay pressed out from the clay pressing-out tool 10 is pressed and a desired molded figure is formed, and a shaping support tool 30, with which an additional form portion is stamped.

A cylindrical hole 11a is formed in the upper portion of a case 11 of the clay pressing-out tool 10, as shown in FIG. 2. A cylindrical block 12 is provided to be slidably in the hole 11a. A clay accommodating recess portion 13 is provided by the upper surface of the block 12 and the hole 11a. Further, a shaft 14 in the case 11 holds the middle portion of a lever 15. The lever 15 is biased toward the counterclockwise direction in FIG. 2 by a spring 16 laid between the lever 15 and the case 11. Moreover, a long hole 17 is formed in the tip of the lever 15. A pin 18 provided to project from the lower peripheral surface of the block 12, is fitted loosely in the long hole 17. Furthermore, the case 11 comprises a claw 19, which latches the mold 20 and an edge around the opening of the hole 11a together.

On the other hand, the mold 20 has a dome-shape body, and comprises a frange 21 in the edge around the lower portion. The surface form of the mold 20 is shell form. As patterns 2, for example, the tortoiseshell patterns are drawn on its surface, as shown in FIG. 1. Then, holes 22a, 22b and 22c are formed in order to form a head portion 3a and leg portions 3b and 3c or the like of a molded FIG. 1.

Further, the shaping support tools 30 comprise a stamp portion 31, on which a salient portion 31a for forming the eyes and mouth or the like of the head portion 3a of the molded FIG. 1, or a salient portion 31b for forming the claw of the leg portions 3b and 31c, or the like are provided, and a handle 32. Although the main portion of the stamp portion 31 is not limited particularly, it is preferred being made of rubber. It is also preferable to provide a small air hole thereon for removing air out, since shaping becomes easy. In addition, a shaping support tool of a knife or others can also be added as a shaping support tool.

The molded FIG. 1 is made as following, by using the clay molding device constituted as above.

At first, clay is filled into the clay accommodating recess portion 13 of the clay pressing-out tool 10. Then, as shown in FIG. 3A, the frange 21 of the mold 20 is engaged with the claw 19, and the mold 20 is latched to the clay pressing-out tool 10 as covering the opening portion of the clay accommodating recess portion 13.

Next, when the lever 15 is pressed down, the clay in the clay accommodating recess portion 13 is pressed up by the block 12, and then pressed in the mold 20. Then, the eyes, mouth and claw or the like are stamped by the shaping support tools 30 in the state that the clay is filled up (pressed in) to some extent in the mold 20, that is, the state that the clay is occupied in the holes 22a, 22b and 22c of the mold 20, as shown in FIG. 3B. Then, when the lever 15 is further pressed down, as shown in FIG. 1, the clay is pressed out through those holes 22a, 22b and 22c, and consequently, the head portion 3a and the leg portions 3b and 3c are formed.

Thus, when the molded FIG. 1 is formed, the mold 20 is removed from the clay pressing-out tool 10, and the bottom of the molded figure is smoothed by a knife or the like, and it is completed. In the molded FIG. 1 formed as above, the mold 20 is left as a portion of the molded FIG. 1. In addition, the protruding and shaping portion may be bent by hand, or another form may be added by a knife or the like, if needed.

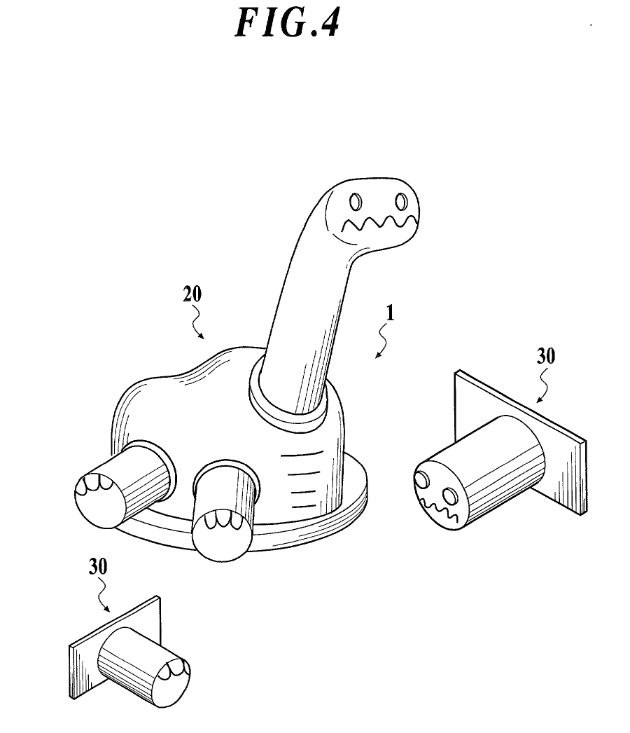

In the above-described embodiment, a “tortoise” is shown as a molded figure. However, as shown in FIG. 4, a “dinosaur” can be molded by changing the mold 20 and the shaping support tools 30.

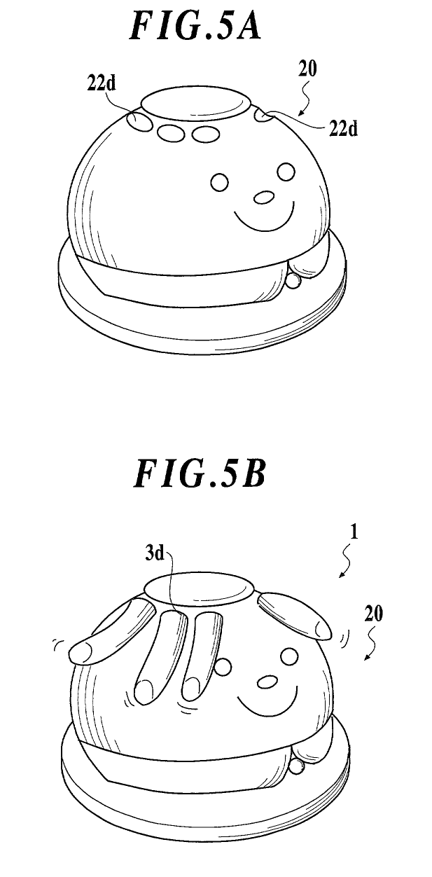

Further, as shown in FIG. 5B, hair 3d of a doll can be formed by forming holes 22d on the upper portion of the mold 20, as shown in FIG. 5A.

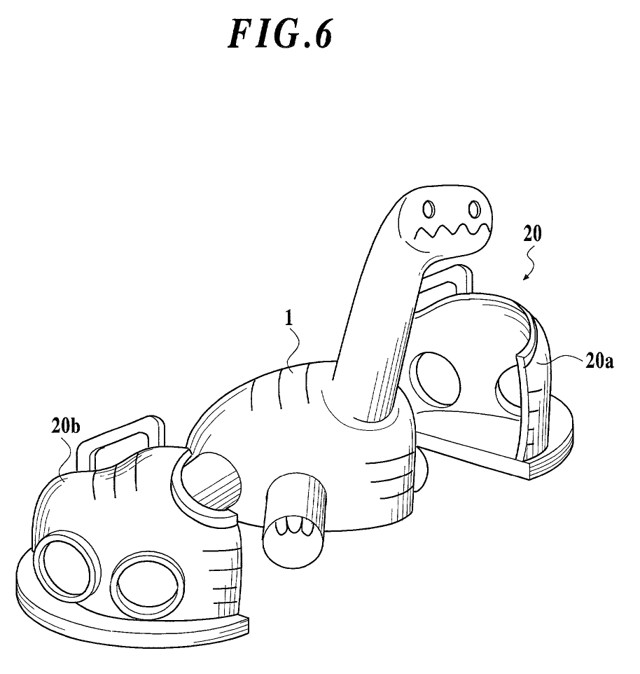

Moreover, as shown in FIG. 6, divided molds 20a and 20b may be used as a mold 20. In this case, since clay can be separated from the divided molds 20a and 20b after molding, a molded FIG. 1 which consists only of clay, is obtained.

In the above, the embodiment of the present invention is explained. However, it is needless to say that the present invention is not limited to such embodiment, but various modifications are possible in a range within the scope of the present invention.

For example, in the embodiment, the necessity for providing an air hole on a shaping support tool 30 is explained. However, an air hole may also be provided suitably with a sub-mold, which is used as adding to the shaping support tool 30 or replacing with it. Particularly, when the inner surface form of the mold becomes complex, air is enclosed during filling-up of clay, so that the clay cannot be filled up densely. Therefore, it is useful to provide an air hole.

According to the clay molding device, since the mold, the clay pressed in the mold, and the clay protruded and shaped through the hole and/or the notch may be united to form a clay molded figure, the clay molded figure having a protruding and shaping portion, which extends toward the arbitrary direction according to the mold, may be obtained. Further, the appearance form of the mold itself can be constituted complexly. Therefore, a novel, extravagant, and good-appearance clay molded figure, may be obtained.

In the clay molding device, after clay is molded, the mold can be separated from the clay molded figure, while the hole and/or the notch is formed on the mold. Therefore, a novel, extravagant and good-appearance clay molded figure of clay only, having a protruding and shaping portion that extends toward the arbitrary direction according to the mold, may be obtained.

Further, in the clay molding device of the present invention, since form can be added to the clay protruded through a hole and/or a notch, additional form portions, such as eyes, mouth or the like, can be drawn, so that a clay molded figure that is rich in change, can be obtained.

Moreover, in the clay molding device of the present invention, since form can be added to the clay protruded through a hole and/or a notch beforehand, finite form can be added. Therefore, the protruding process of the additional form portion can be enjoyed visually.

Furthermore, in the clay molding device of the present invention, since a sub-mold is used, complex and finite form can be easily added to the clay protruded through a hole and/or a notch.

According to the mold, since the mold, the clay pressed in the mold, and the clay protruded and shaped through the hole and/or the notch are united to form a clay molded figure, the clay molded figure having a protruding and shaping portion, which extends toward the arbitrary direction according to the mold, is obtained. Further, the appearance form of the mold itself can be constituted complex. Therefore, a novel, extravagant, and good-appearance clay molded figure, is obtained.

Further, according to the mold, after clay is molded, the mold is capable of being separated from the clay molded figure, while the hole and/or the notch is formed on the mold. Therefore, a novel, extravagant and good-appearance clay molded figure of clay only, having a protruding and shaping portion that extends toward the arbitrary direction according to the mold, is obtained.

The entire disclosure of Japanese Patent Application No. Tokugan 2000-142097 filed on May 15, 2000 including specification, claims, drawings and summary are incorporated herein by reference in its entirety.

What is claimed is:

1. A clay molding device comprising:
a clay pressing-out tool pressing filled-up clay out through an opening; and
a mold being installed as covering the opening of the clay pressing-out tool to be attached and detached freely, in which clay is pressed through the opening of the clay pressing-out tool and at least one of a hole and a notch is formed, and a portion of the pressed-in clay is capable of being protruded and shaped thereof by the hole and the notch.

2. The clay molding device as claimed in claim 1, wherein the mold is united with the clay pressed in an inside and the clay protruded and shaped by the hole and the notch, and is capable of forming a portion of an appearance of a clay molded figure.

3. The clay molding device as claimed in claim 1, wherein the mold is capable of being divided, and after molding of clay, the mold is capable of being separated from a clay molded figure, and a clay molded figure, with which the clay pressed in the inside of the mold and the clay protruded and shaped the hole and the notch are united, is capable of being formed.

4. The clay molding device as claimed in claim 1, comprising an extra shaping support tool, with which form is added to the clay protruded and shaped by the hole and the notch.

5. The clay molding device as claimed in claim 4, wherein the main portion of the shaping support tool is capable of being inserted in and pulled out through the hole and the notch.

6. The clay molding device as claimed in claim 4, wherein the shaping support tool is constituted as a sub-mold being installed attachably and detachably on the outside of the mold, adding form to the clay protruded and shaped by the hole and the notch, and being capable of being taken out after molding of clay.

7. A mold comprising a body having at least one of a hole and a notch,
wherein an inside of the mold is capable of being filled up with clay, and clay is capable of being protruded and shaped by using the hole and the notch; and
wherein the mold is united with the clay filled up in the inside of the mold and the clay protruded and shaped by using the hole and the notch, and is capable of forming a portion of an appearance of a clay molded figure.

8. A mold comprising a body having at least one of a hole and a notch,
wherein an inside is capable of being filled up with clay, and clay is capable of being protruded and shaped by using the hole and the notch; and
wherein the mold is capable of being divided, and after molding of clay, the mold is capable of being separated from a clay molded figure.
